(19) United States
(12) Patent Application Publication
(10) Pub. No.: US 2018/0008082 A1
(43) Pub. Date: Jan. 11, 2018

(54) Cooking Aid for Partially Sliced Food

(71) Applicant: Richard Arnold Dasen, JR., Kalispell, MT (US)

(72) Inventor: Richard Arnold Dasen, JR., Kalispell, MT (US)

(21) Appl. No.: 15/713,638

(22) Filed: Sep. 23, 2017

Related U.S. Application Data
(63) Continuation-in-part of application No. 14/924,412, filed on Oct. 27, 2015.
(60) Provisional application No. 62/073,715, filed on Oct. 31, 2014.

(51) Int. Cl. A47J 27/00; A47J 36/16

(52) U.S. Cl. CPC A47J 27/002; A47J 36/16; A23L 19/12; A23V 2002/00

(57) ABSTRACT

A cooking device having an arch to expand partially sliced food, such as food sliced by accordion or Hasselback techniques, during the cooking process. The device must comprise at least one arch with a convex section having a food expansion support. In a preferred consumer embodiment, the device is a pan insert with the required arch and food expanding support surface. A fanning plate for a baked potato also provides an arched top surface to fan out the slices of a Hasselback potato during the seasoning and baking process, allowing the potato slices to crisp properly. The fanning plate includes raised rims and endcaps to keep the seasoning contained and prevent a mess. Multiple plates may be used at once and when not in use may be stacked atop one another for storage.

### CROSS-REFERENCE TO RELATED APPLICATIONS

This patent application is a continuation-in-part of U.S. Utility application Ser. No. 14/924,412 entitled “Fanning plate for a baked potato” filed on Oct. 27, 2015, which application is currently pending, and thus claims priority to U.S. Provisional Patent Application also entitled “Fanning plate for a baked potato”, with application No. 62/073,715, and filed on Oct. 31, 2014. The entire disclosures of these patent applications are hereby incorporated by reference.

Richard Arnold Dasen, Jr., a citizen of the United States of America residing in Kalispell, Montana has invented a new, useful and non-obvious Cooking Aid for Partially Sliced Food.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### Field of the Invention

This invention relates to devices for cooking, and more particularly to a cooking aid for partially sliced food, also called Hasselback or accordion sliced food.

### Description of the Related Art

In recent years there has been a growing interest in Hasselback potatoes. A Hasselback potato is not a variety of potato but rather a method of cutting and cooking a potato. Whole potatoes are cut in such a way as to resemble a fan or accordion. When cooked, the outside of the potato becomes crisp and brown while the inside is soft. It is believed that the name Hasselback is derived from the restaurant where they were first introduced in the 1940s—Hasselbacken in Stockholm, Sweden. There the potatoes are called hasselbackspotatis.

While Hasselback is generally used to refer to a method of cutting and cooking a variety of potato, this method of cutting a food item in the general shape of an accordion or fan can be applied to a wide variety of foods including meat, vegetables, fruits, breads, and cheeses. Cooking a Hasselback-sliced food involves slicing the food laterally in thin slices such that it is cut almost through, with a bit of the food (such as the skin and a bit of potato) left intact to hold the slices together. Oil and seasonings are applied atop the food item and in between the slices. The sliced food is cooked such as by baking, roasting, broiling, or grilling.

While foods like Hasselback potatoes are simple to prepare, cooking constraints make certain varieties of food better suited to this type of dish than others. Food safety requires consistent cooking temperatures but the variation in the food's structure make that consistency difficult to achieve when using this cutting and cooking technique. Some recipes have sought to meet the objectives of better cooking the Hasselback potatoes by having the potatoes snake back and forth within a flat pan but these efforts have fallen short of fulfilling the need to properly cook Hasselback foods. There is a need for a cooking device to aid in the proper cooking of Hasselback-sliced foods.

### BRIEF SUMMARY OF THE INVENTION

Accordingly, the present invention is directed to a cooking device to aid in the proper cooking of Hasselback-sliced foods. The food cooking aid comprises a convex section, or a hump, which creates a food-expansion support surface to receive the uncut portion of partially sliced food items. The convex cooking surface supports the uncut portion of the food in a manner that allows and encourages the, upper parallel cut sections of the food to expand, or fan out. The fanning out of the slices permits better penetration of heat, oils, and seasonings into the center of the food, leaving the uncut section consistently and sufficiently cooked while the sliced sections are desirably crispy to a deeper depth in the slices. While a solid convex form could serve the purpose of expanding the sliced food for cooking, the convex section of the preferred embodiment also has an opposing concave void. The concave void helps convey the heat to the underside of the food item.

The convex cooking aid may be provided as a singular arched cooking apparatus made of material suitable to withstand cooking temperatures in ovens, roasters, grills, or microwaves. This cooking arch may be used directly on an oven or grill rack. In another embodiment of the invention, the convex section may be incorporated within or presented as a part of a pan insert. The pan insert includes the cooking arch. In this version, the pan insert is preferably laid upon another cooking vessel, such as a cookie sheet or baking pan. The preferred embodiment of the pan insert version of the food cooking aid further comprises a flat portion on either side of the convex section. The underside of the flat portion rests upon the complementary flat surfaces of flat-bottomed cookware such as cake pans or cookie sheets. In this embodiment, the flat portion supports the cooking arch and may also support portions of the food. The pan insert version may have stability ridges to add support to the flat section of the cooking aid. The pan insert may also be provided with one or more food cradling grooves that permit additional air flow under the uncut portions of the food and the food cradling groove also receive the food to hold it in place over the arch. In these variations, the food cradling grooves provide stability to the convex cooking arch. The stability from the ridges and grooves will prevent the warping and bending of the cooking aid.

An embodiment of the present invention may also be a stand-alone piece of arched cookware complete with one or more raised rims and one or more endcaps to control spills. In this first embodiment, two endcaps are located on either side, parallel to the convex section and raised rims abut each end of the arch.

The various embodiments may be provided with single or multiple arches. Embodiment may also be provided in assorted sizes or with varying degrees of curvature. Variations of size and number are considered part of this invention so long as the objectives of the invention are met.

In an example, stand-alone embodiment, the cooking aid is described as a fanning plate for a baked potato. The essence of this fanning plate embodiment provides a top surface and an arch to fan out the slices of a Hasselback potato during the seasoning and baking process. The fanning plate is particularly useful in crisping the potato slices. To keep the seasonings contained and prevent a mess, the fanning plate embodiment further comprises raised rims following the edge of the fanning plate and a pair of endcaps located on either side of the arch. The endcaps are particularly useful when a large quantity of oil is applied to help crisp the potato slices.

The present invention properly cooks Hasselback sliced foods. Heat is enabled to reach both cut and uncut surfaces of Hasselback sliced foods when the present invention is used. The thin surfaces of the vertical slices are allowed to crisp but not overcook since the uncut portions are exposed to more uniform and complete heat which safely and thoroughly cooks the food. The present invention further allows uniform and complete penetration of oils, seasonings, spices and other flavors into needed areas of the Hasselback cooked foods.

More specifically, and in a presently preferred embodiment, by way of example and not necessarily by way of limitation, a cooking device is provided for partially sliced food having a food receiving arch to receive the bottom portion of a food item cut using a Hasselback technique. Prior to cooking, the food item is placed on the food receiving arch.

Additional features and advantages of the invention will be set forth in the description which follows, and will be apparent from the description, or may be learned by practice of the invention. The foregoing general description and the following detailed description are exemplary and explanatory and are intended to provide further explanation of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The accompanying drawings are included to provide a further understanding of the invention and are incorporated into and constitute a part of the specification. They illustrate embodiments of the invention and, together with the description, serve to explain the principles of the invention. The drawings describe by illustration, the advantages and objects of the present invention. Each drawing is referenced by corresponding figure reference characters within the “DETAILED DESCRIPTION OF THE INVENTION” section to follow.

FIG. 1 is a front view of a first embodiment, displaying the plate 10, the arch 22, and rim 12 bordering the top arch surface 11 (not visible in FIG. 1).

FIG. 2 is a top view of the first embodiment, displaying the plate 10, the top surface 11 of the arch 22, the rims 12, and the endcaps 13.

FIG. 3 is an end view of the first embodiment, displaying the plate 10, the arch 22, the top surface 11, the rims 12, and an endcap 13.

FIG. 4 is a front perspective view of the first embodiment, displaying the plate 10, the arch 22, the top surface 11, the rims 12, and an endcap 13.

FIG. 5 is a front view of a second embodiment, displaying the plate 50, the pair of arches 502, and the rim 52 bordering the length of the device.

FIG. 6 is a top view of the second embodiment, displaying the plate 50, the pair of arches 502, the central flat region 501, the top surface 51, the rim 52, and the endcaps 53.

FIG. 7 is a front perspective view of the second embodiment, displaying the plate 50, the pair of arches 502, the central flat region 501, the top surface 51, the rim 52, and the endcaps 53.

FIG. 8 is a perspective view of the preferred pan insert embodiment.

FIG. 9 is a front perspective view of the preferred pan insert embodiment.

FIG. 10 is a top perspective view of the preferred pan insert embodiment.

FIG. 11 is a front perspective view of the preferred pan insert embodiment during use, showing food positioned for cooking as the pan insert rests atop the flat surface of a baking dish upon an oven rack.

FIG. 12 is a top view of the preferred pan insert embodiment.

FIG. 13 is an end view of the preferred pan insert embodiment. The first end view and the second end view are mirror images of one another.

FIG. 14 is a front view of the preferred pan insert embodiment. The rear view is the mirror image of the front view.

### LIST OF REFERENCE NUMERALS

2 Pan Insert
21 Flat Surface with a top and an underside
22 Arched Cooking Surface also called an arch or arches (formerly referred to as 10A)
23 Stability Ridge
24 Food Cradling Groove
25 Food
26 Baking Sheet
27 Oven Rack
10 Plate
11 Top Arch Surface
12 Raised Spill Rims
13 Endcaps
50 Multi-arch Plate
51 Arch Top Surface
501 Central Flat Region (formerly referred to as 50B)
502 Arches (formerly referred to as 50A)
52 Multi-arch Raised Spill Rim
53 Multi-arch Endcaps

### DETAILED DESCRIPTION OF THE INVENTION

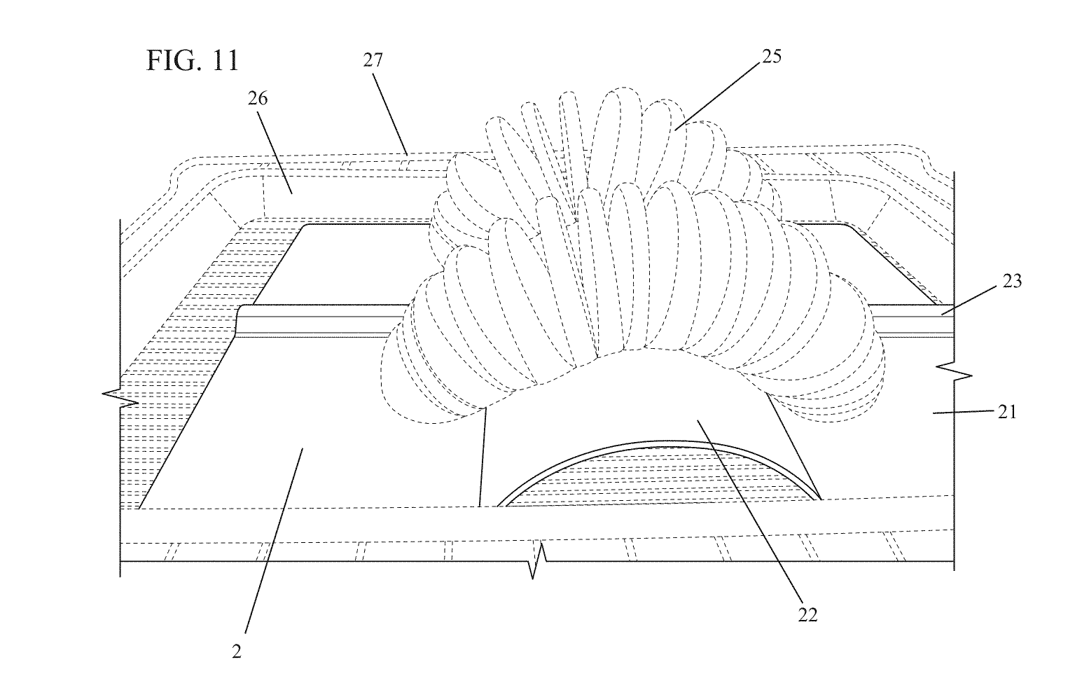

Referring now to the figures, the invention is a new and non-obvious cooking aid formed by an arched-food receiving surface particularly accommodating for partially sliced food. FIG. 11 demonstrates an example of partially sliced food during cooking with the present invention. The example food 25 illustrated in FIG. 11 is a potato.

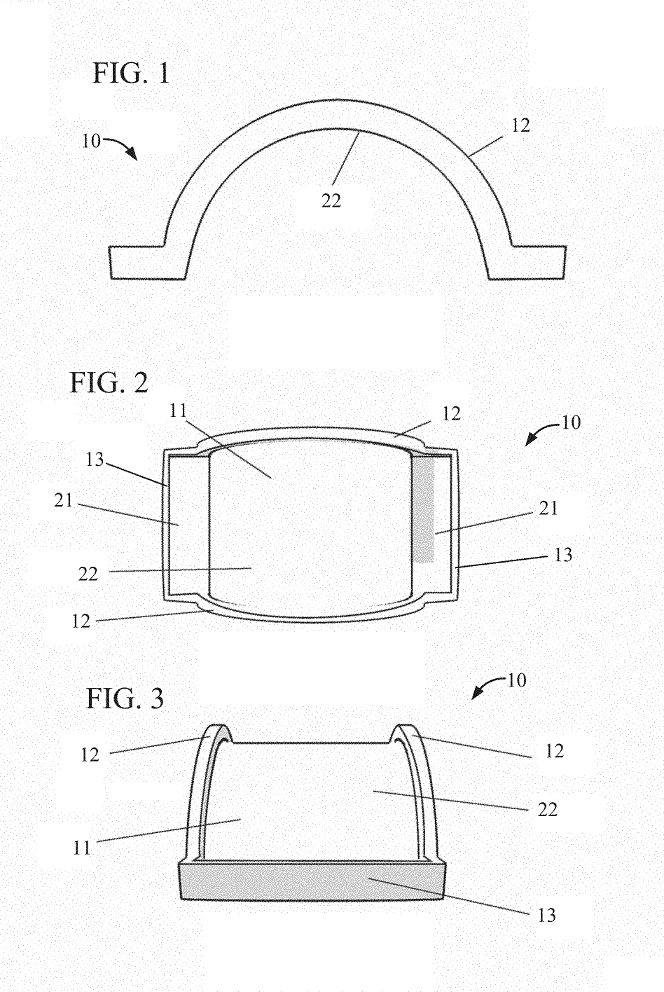

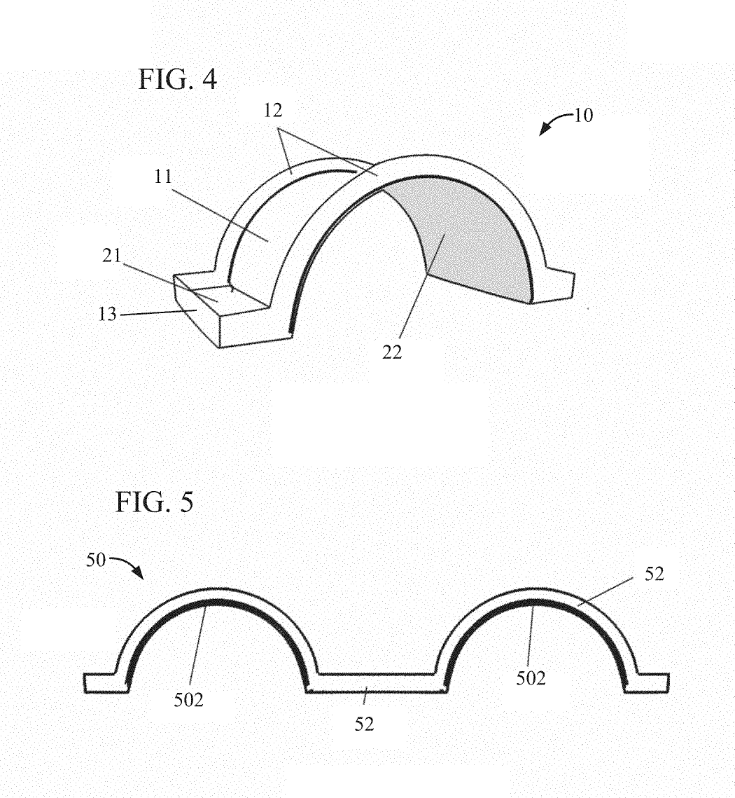

With reference to FIGS. 1-4, the first embodiment is comprised of a fanning plate 10 which provides a top surface 11 over an arch 22 to fan out the slices of a Hasselback potato during the seasoning and baking process, allowing the potato slices to crisp properly. The first embodiment includes raised rims 12 and endcaps 13 to keep the seasonings contained and prevent a mess. FIG. 1 clearly illustrates the convex cooking surface arch opposite of the concave void. Multiple plates 10 of this embodiment may be easily stacked for compact storage.

To use the first embodiment for a potato, the user may place the potato on a counter or other preparation surface and cut the potato into thin slices, not quite cutting all the way through. The user will then transfer the potato to the plate 10, uncut side down, and may fan out the slices of the potato over the top surface 11 and sprinkle the seasonings between the slices. An example of fanned slices of a potato are illustrated in FIG. 11. One or more plates 10 bearing potatoes with seasonings, may then be placed into the oven for baking.

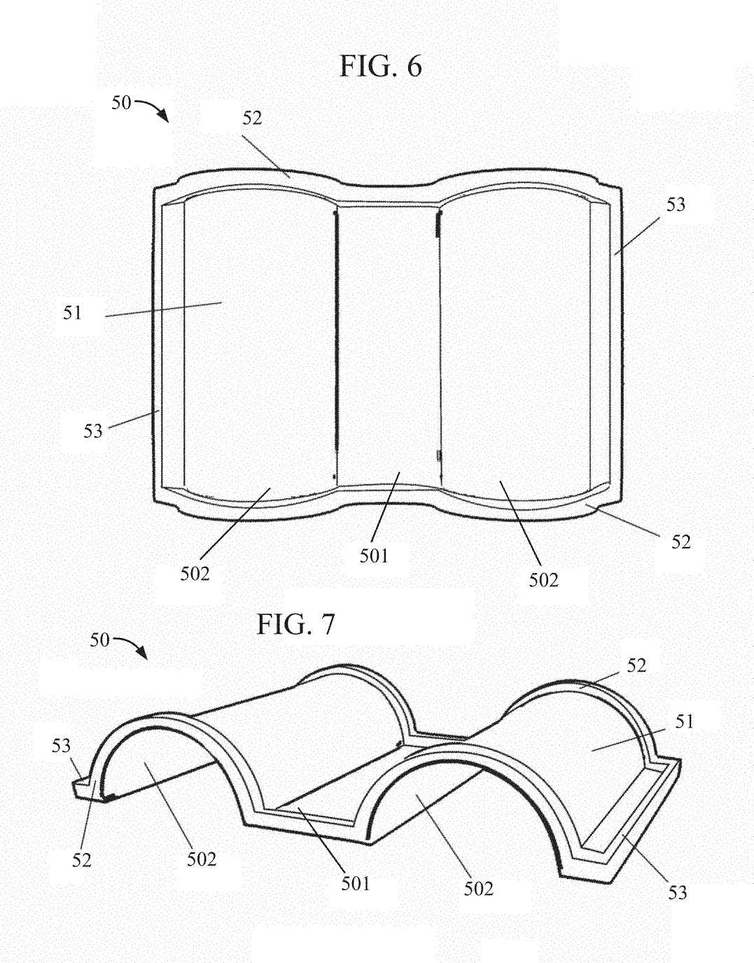

Referring to FIGS. 5-7, in a second embodiment a larger plate 50 may have about the footprint of a cookie sheet. The larger plate 50 is preferably structured with a pair of arches 502, or more, separated by a central flat region 501, with endcaps 53 at either end. The larger plate 50 has a top surface 51 extending over both of the arches 502, the central flat region 501, and the endcaps 53. A rim 52 extends up from the front and rear edges of the larger plate 50 and connects to the endcaps 53 creating a perimeter around the larger plate 50. The larger plate 50 is preferably of a size sufficient to accommodate multiple potatoes side by side on the same arch 502, for example having a capacity of four or six baked potatoes, two or three on each arch 502.

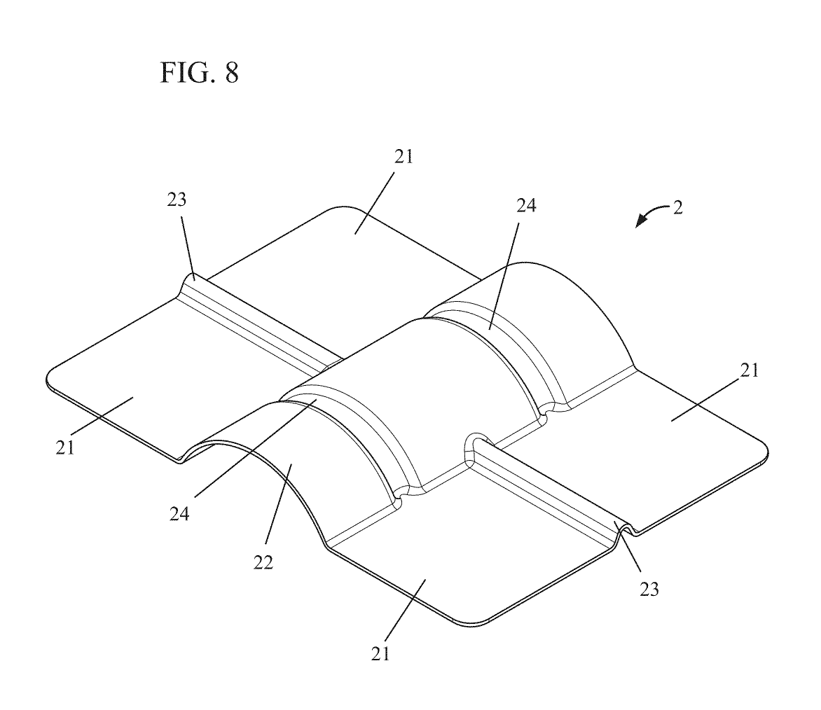

A presently preferred pan insert embodiment is illustrated in FIGS. 8-14. In this preferred embodiment of the present invention, the arch 22 (or more in multi-arch variations) is presented as part of a pan insert 2. The pan insert 2 is formed with at least one flat surface 21 to rest upon a pan 26 (see FIG. 11). The arched cooking surface 22 is accompanied by at least one, and preferably a set of food receiving grooves 24. The grooves 24 serve to cradle the food on the arch 22 and also add stability. The pan insert 2 is also accompanied by stability ridges 23 which extend from the arch 22 through the flat section 21 to prevent bending of the pan insert 2 and to support the arch 22 when food items are placed thereon. With continuing reference to FIG. 8, in the single arch version of the pan insert 2 illustrated in FIGS. 8-14, four flat surfaces 21, two stability ridges 23, and two food receiving grooves 24 are provided.

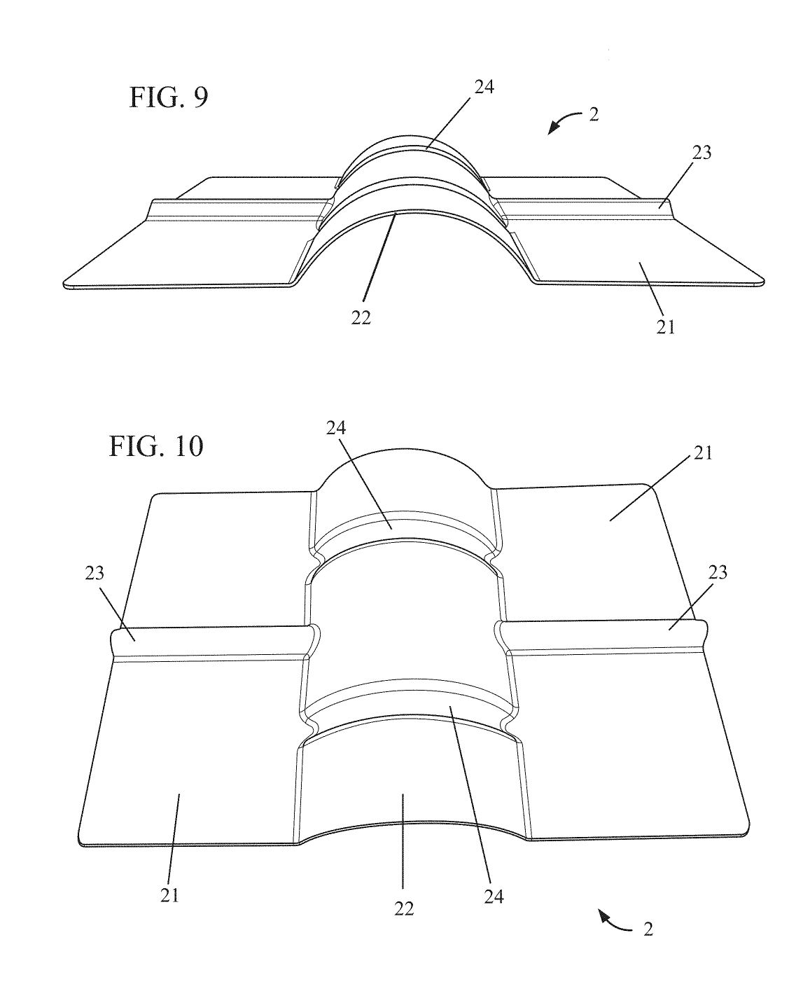

As shown in FIGS. 9 and 14, the underside of the arch 22 is hollow, or creates a void space. The void space is also visible in the other embodiments (illustrated in FIGS. 1, 4, 5 and 7). The void space functions to allow air and thus, heat, to circulate under the bottom of arch 22. The heat circulating under the arch 22 reaches the food 25 (see FIG. 11) in a more uniform manner when the pan insert 2 is in place on a pan 26 for cooking.

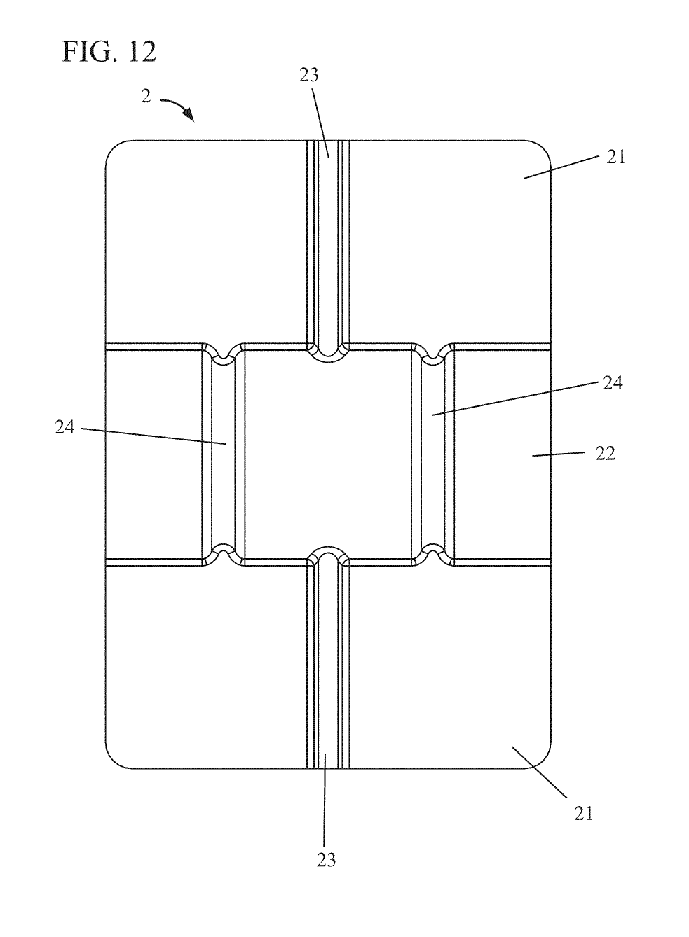

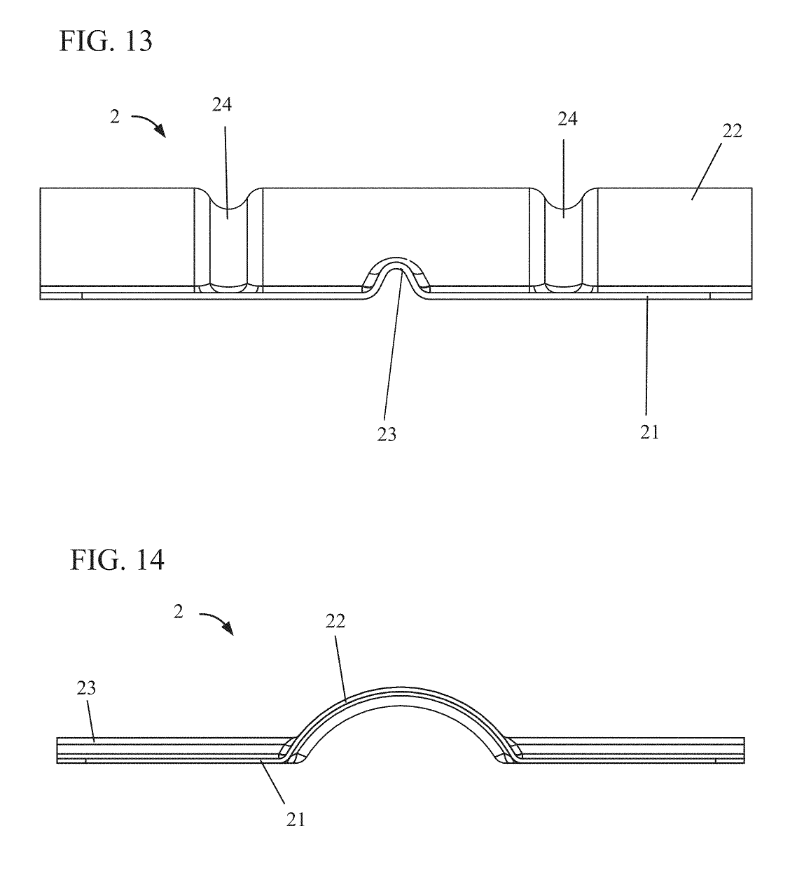

The depth of the food receiving grooves 24 relative to the arch 22 of this pan insert embodiment is visible in FIGS. 10 and 13. In this embodiment, the stability ridges 23 are offset and centered between the food receiving grooves 24 to provide additional structural support to the pan insert 2 as shown in FIG. 12. The relative depth of the stability ridges 23 according to this embodiment are best illustrated in FIG. 13.

While various embodiments have been illustrated it should be understood that the minimum required for the invention to meet the objectives stated herein is an arch 22 having a top surface for receiving a partially-sliced food item for cooking. The food items may be selected from any foods that may be cooked after slicing, such as vegetables, fruits, meat, breads, pastas, cheeses, or the like. The cooking means may be by any known means for exposing food to air for cooking such as by oven, broiler, roaster, microwave, grill, or similar means.

The present invention permits access to a wider variety and sizes of foods for those seeking to use Hasselback or accordion sliced cooking techniques. Normally, medium sized potatoes with an oblong or oval shape are perfectly suited to a Hasselback dish and will continue to be ideal even through use of this invention. While a typical baking potato works best for conventional Hasselback cooking methods, with implementation of the various sizes of arches of the present invention, any size of a potato or other food item may be prepared using these techniques. Very large potatoes are typically not well suited to Hasselback style dishes but with the present invention, particularly the preferred embodiment illustrated in FIGS. 8-14, very large potatoes, sweet potatoes, or zucchinis become Hasselback dishes fit for the whole family. Even very small potatoes such as fingerling or new potatoes become good candidates for Hasselback potatoes. For situations where single service is desired, the employment of alternative designs of pan inserts with a larger number of smaller arches allows single-service for many individuals or when one or two potatoes per person is desired such as for catering or appetizers.

FIG. 11 illustrates an example of a Hasselback potato 25 cooking atop an arch 22 according to the present invention. In this example, a pan insert 2 is sitting within a pan 26 on an oven rack 27. To arrive at the cooking stage of a Hasselback potato shown in FIG. 11, a user follows the following steps of potato preparation:
1. Place sticks provided with the pan insert purchase or chop sticks on either side of the potato; alternatively, a curved cutting board, or, for smaller potatoes, a curved wooden spoon can serve as a stage for the potato cutting step.
2. Using a sharp kitchen knife, slice the potato cross ways (perpendicular to the longest side of the potato), straight down (vertically), at ⅛-inch to ½-inch intervals, until the knife is stopped by the sticks or the sides of the spoon.
3. Transfer the potato to the arched cooking surface of the present invention and center it over the arch. The uncut side of the potato should be in contact with the top surface of the arch.
4. Gently pull the ends of the potato down toward the flat surfaces 21 of the pan insert thereby fanning the potato slices open.
5. Brush the potato with oils and seasonings or insert other foods (such as cheese, bacon, or tomatoes) in between the slices for additional texture, variety, and flavor.
6. Repeat the above steps for additional potatoes, many times over for smaller potatoes or not at all for very large potatoes.

Once in the oven as illustrated in FIG. 11, the potatoes need only cook for about two-thirds of the time a particular Hasselback recipe recommends since the use of the present invention reduces cooking time substantially. The potatoes are removed from the oven once cooked to a desired crispness or softness. It is plated under normal circumstances and the Hasselback potato will return to a non-fanning display. The food is not permanently molded to the shape of the cooking surface of the arch 22. Thus, unless inserted ingredients are separating the sections of the food, the partially sliced food returns to the more compressed accordion formation

The instructions given above refer to potatoes specifically, but these instructions may be employed with various other food items. The preferred application will be with food items that may be sliced prior to cooking and which call for cooking in an oven or similar cooking appliance. By way of example and not by limitation, the present invention has been demonstrated in use with sweet potatoes flavored with brown sugar and butter, chicken breasts flavored with oils and herbs, pork loin brushed with oiled and filled with stuffing between the slices, sausages having peppers or cheese inserted between its slices, French bread with garlic and butter, apples flavored with cinnamon and sugar, and zucchini oiled and herbed. Many analogous recipes will be immediately apparent based on this set of examples. Cooking time for meat will be reduced by as much as one-half of the time recommended in a particular recipe and therefore internal food temperatures should be carefully monitored to prevent overcooking or undercooking.

The present invention will be constructed of any materials which may be received in the applicable cooking appliance. The fanning plate embodiments are preferably manufactured from a rigid, durable material which is heat resistant and dishwasher safe, such as stainless steel, aluminum alloy, or tempered glass. Additionally, steel, stainless steel, and aluminum with non-stick surfaces will be useful for the pan insert 2 to be used in an oven or other fire-based cooking appliances. Glass, Pyrex®, and reinforced silicone will be useful in conventional or microwave ovens. Certain plastics or poly blends will be useful in microwave ovens. According to the minimum, arch-only embodiment of the present invention, no ledges, edges, or supports are required. Thus, any material that can hold the form of the arch, is food safe, and can be heated to approximately 500 degrees Fahrenheit either by fire-based heating appliances or ovens, or in microwave ovens will be useful as a material for construction. One Pyrex® embodiment is an injection molded glass dish with sides approximately 1.5 inches in depth and two separate arches within the dish similar in appearance to the embodiment illustrated in FIG. 5-7.

Components, component sizes, and materials listed above are preferable, but artisans will recognize that alternate components and materials could be selected without altering the scope of the invention. The dimensions of the preferred pan insert 2 embodiment calls for external dimensions of about 8.5 inches by 12 inches, thus fitting within a standard 9-inch by 13-inch baking dish such as used for standard size cake pan, cookie sheet, or a jelly roll pan. Alternative cooking vessels that have sufficient height and width to receive the pan insert and having a small side wall to contain any drippings or juices would also work. The arch 22 of the preferred embodiment has a height of approximately 1.25 inches and is approximately 4 inches wide. When the arch 22 is accompanied by a pan insert 2 then the general shape will be that of a rectangle. The center height of the arch of the pan insert 2 is between one and 1.5-inches. The four flat surfaces of the preferred embodiment of the pan insert are approximately 4 inches by 4 inches. The dimensions of the arch must be sized to be not too steep or too pronounced or else the fanning of the food item will be too severe and cause the food item to break into pieces before, during, or after cooking. The minimum arch 22 radius is illustrated in the preferred pan insert embodiment described herein, with an arc angle of approximately 120 degrees.

For any of the embodiments disclosed herein, storage may be consolidated by stacking the arches with the arch voids. When fanning plates in multiple are used, they can also be stored by stacking and interlocking the arches, raised rims and endcaps. The pan insert will also lay one atop the next for storage purposes.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

It is further intended that any other embodiments of the present invention which result from any changes in application or method of use or operation, method of manufacture, shape, size, or material which are not specified within the detailed written description or illustrations contained herein yet are considered apparent or obvious to one skilled in the art are within the scope of the present invention.

I claim:

1. A food cooking aid comprising:
a convex section having a food expansion support surface wherein the food expansion support surface receives an uncut bottom of a food item.

2. The food cooking aid of claim 1, wherein the food item is vertically sliced opposite the uncut bottom such as by a Hasselback technique.

3. The food cooking aid of claim 2, wherein the food item is a potato.

4. The food cooking aid of claim 2, wherein the food item is one of a vegetable, fruit, meat, cheese or bread.

5. The food cooking aid of claim 1, wherein the convex section is disposed opposite a concave void.

6. The food cooking aid of claim 1, wherein the food cooking aid is part of a pan insert.

7. The food cooking aid of claim 6, wherein the pan insert further comprises at least one stability ridge.

8. The food cooking aid of claim 6, wherein the pan insert further comprises at least one food cradling groove.

9. The food cooking aid of claim 1, wherein the food cooking aid is a stand-alone cooking pan.

10. The food cooking aid of claim 1, where in the food cooking aid further comprises a flat portion on either side of the convex section.

11. A Hasselback food cooking aid comprising:
an arch formed to receive an underside of a food item
wherein the food item is sliced according to Hasselback techniques.

12. The Hasselback food cooking aid of claim 11, wherein the arch is inserted into another cooking vessel prior to cooking.

13. The Hasselback food cooking aid of claim 12, wherein the cooking vessel is a baking pan.

14. The Hasselback food cooking aid of claim 11, wherein the food item is one of a vegetable, fruit, meat, or bread.

15. The Hasselback food cooking aid of claim 11, wherein the arch has a void thereunder.

16. The Hasselback food cooking aid of claim 11, wherein the Hasselback food cooking aid is part of a pan insert.

17. The Hasselback food cooking aid of claim 17, wherein the pan insert further comprises at least one stability ridge.

18. The Hasselback food cooking aid of claim 11, wherein the arch further comprises at least one food cradling groove.

19. The Hasselback food cooking aid of claim 11, wherein the Hasselback food cooking aid is a stand-alone cooking pan.

20. A cooking device having a food receiving arch wherein a food item is partially sliced using a Hasselback technique leaving an uncut food bottom to be placed on the food receiving arch prior to cooking.
